(19) United States
(12) Patent Application Publication
(10) Pub. No.: US 2015/0154590 A1
(43) Pub. Date: Jun. 4, 2015

(54) METHOD AND SYSTEM FOR LEVERAGING TRANSACTION DATA TO FACILITATE MERCHANT OPERATIONS

(71) Applicant: MasterCard International Incorporated, Purchase, NY (US)

(72) Inventors: Debashis Ghosh, Charlotte, NC (US); Randy Shuken, Westport, CT (US); Therese Burke, Stamford, CT (US)

(73) Assignee: MasterCard International Incorporated, Purchase, NY (US)

(21) Appl. No.: 14/097,021

(22) Filed: Dec. 4, 2013

(51) Int. Cl. G06Q 20/38; G06Q 40/00

(52) U.S. Cl. CPC G06Q 20/38; G06Q 40/125

(57) ABSTRACT

A method and system for facilitating merchant operations is provided. The method includes receiving payment transaction data associated with a plurality of payment transactions. The payment transaction data includes timestamp data indicative of a time of each payment transaction. The method also includes determining a transaction count for each of a plurality of time periods of interest based on the timestamp data. Each transaction count indicates the number of transactions performed with a merchant during the respective time period of interest. The method also includes generating a transaction matrix for the merchant. The transaction matrix includes a plurality of cells, and each cell is associated with a respective time period of interest. The method also includes populating each cell of the transaction matrix with the transaction count associated with the time period of interest of the cell, and transmitting at least a portion of the transaction matrix to the merchant.

### BACKGROUND OF THE DISCLOSURE

The field of the disclosure relates generally to a payment network for processing payment transactions between a cardholder and a merchant, and more specifically, to a method and system for processing transaction data associated with the payment transactions to facilitate merchant operations.

In general, merchants, such as retailers, distributors, service providers, etc. provide goods and/or services to customers in return for a fee or other compensation. However, merchants may also incur operating costs and expenses associated with providing the goods and/or services to the customers. For example, to facilitate sales, known merchants typically have employees that assist customers in the purchase of goods or perform services for the customer on behalf of the merchant. For example, an employee may serve as a cashier to process payments from the customer to the merchant. In another example, an employee may serve as a mechanic that repairs an automobile of the customer on behalf of the merchant. In return for their work, employees are generally paid a salary, or some other form of compensation. In addition to employees, merchants may have additional operating expenses, such as heating, lighting, cooling, cleaning, etc.

For known merchants, operating expenses may be significant. In at least some instances, for example, if too many employees are scheduled to work at a given time, the operating expenses of the merchant at the given time may be higher than income generated from customers. To reduce operating expenses, at least some known merchants set their hours-of-operation and employee schedules based on the anticipated amount of business transacted for a particular time period. For example, restaurants are known to schedule additional employees at lunch time or dinner time to accommodate the expected additional customers. However, the business anticipated by the merchant may not be an accurate reflection of the actual number of transactions performed with the merchant during that particular time period.

At least some known merchants collect receipts or sales figures, and analyze the data to more accurately determine the amount of business conducted with the merchant. However, such techniques are typically performed over a long period of time with limited use in day to day operations. Furthermore, such techniques may require the merchant to purchase specialized equipment to capture the data, and/or pay additional employees to analyze and tabulate the data.

Accordingly, there is a need for systems and methods that accurately leverage transaction data to facilitate merchant operations.

### BRIEF DESCRIPTION OF THE DISCLOSURE

In one embodiment, a computer-implemented method for facilitating merchant operations implemented using a server system communicatively coupled to a transaction monitoring module and a memory device, is provided. The method includes receiving, by the transaction monitoring module, payment transaction data associated with a plurality of payment transactions. The payment transaction data includes timestamp data indicative of a time of each payment transaction. The method also includes determining a transaction count for each of a plurality of time periods of interest based on the timestamp data. Each transaction count indicates the number of transactions performed with a merchant during the respective time period of interest. The method also includes generating, using the transaction monitoring module, a transaction matrix for the merchant. The transaction matrix includes a plurality of cells, and each cell is associated with a respective time period of interest. The method also includes populating each cell of the transaction matrix with the transaction count associated with the time period of interest of the cell, and transmitting at least a portion of the transaction matrix to the merchant.

In another embodiment, a server system for facilitating merchant operations is provided. The server system includes a computing device including a memory and a processor coupled to the memory, and a transaction monitoring module coupled to the computing device. The transaction monitoring module is configured to receive payment transaction data associated with a plurality of payment transactions. The payment transaction data includes timestamp data indicative of a time of each payment transaction. The transaction monitoring module is further configured to determine a transaction count for each of a plurality of time periods of interest based on the timestamp data. Each transaction count indicates the number of transactions performed with a merchant during the respective time period of interest. The transaction monitoring module is further configured to generate a transaction matrix for the merchant. The transaction matrix includes a plurality of cells, and each cell is associated with a respective time period of interest. The transaction monitoring module is further configured to populate each cell of the transaction matrix with the transaction count associated with the time period of interest of the cell, and transmit at least a portion of the transaction matrix to the merchant.

In yet another embodiment, a computer readable medium having computer-executable instructions for facilitating merchant operations embodied thereon, wherein, when executed by at least one processor, cause the at least one processor to receive payment transaction data associated with a plurality of payment transactions. The payment transaction data includes timestamp data indicative of a time of each payment transaction. The computer-executable instructions further cause the processor to determine a transaction count for each of a plurality of time periods of interest based on the timestamp data. Each transaction count indicates the number of transactions performed with a merchant during the respective time period of interest. The computer-executable instructions further cause the processor to generate a transaction matrix for the merchant. The transaction matrix includes a plurality of cells, and each cell is associated with a respective time period of interest. Populate each cell of the transaction matrix with the transaction count associated with the time period of interest of the cell, and transmit at least a portion of the transaction matrix to the merchant.

### BRIEF DESCRIPTION OF THE DRAWINGS

FIGS. 1-8 show example embodiments of the method and system described herein.

FIG. 1 shows a system of interrelated steps describing a conventional payment card initiated payment transaction.

FIG. 2 is a simplified block diagram of an example payment system with a server architecture in communication with a transaction monitoring module.

FIG. 3 is an expanded block diagram of an example processing system with a server architecture in communication with a transaction monitoring module.

FIG. 4 illustrates an example configuration of a computing device as shown in FIGS. 2 and 3.

FIG. 5 illustrates an example configuration of a server system as shown in FIGS. 2 and 3 coupled to a transaction monitoring module.

FIG. 6 is a simplified flowchart illustrating an example process implemented by the payment system shown in FIGS. 2 and 3 for leveraging transaction data to facilitate improving merchant operations

FIG. 7 is an example transaction matrix generated by the transaction monitoring module for use in improving merchant operations.

FIG. 8 is a diagram of a component layout of a computing device as shown in FIGS. 2-3.

### DETAILED DESCRIPTION OF THE DISCLOSURE

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to an example embodiment, namely, systems and methods of leveraging transaction data to facilitate merchant operations. However, it is contemplated that this disclosure has general application to leveraging transaction data in industrial, commercial, and residential applications.

As used herein, an element or step recited in the singular and preceded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

Embodiments of the present disclosure describe a payment network that leverages transaction data from payment transactions performed with a merchant to facilitate the operations of the merchant. More specifically, a cardholder initiates a payment transaction with a merchant that communicates with a payment network. As used herein, the term “cardholder” refers to any individual performing a payment transaction that is processed by the payment network, regardless of the form of payment, e.g., credit card, check, debit card, etc. The payment network processes each payment transaction transmitted over the payment network and generates transaction data for each payment transaction. The transaction data includes, but is not limited to, at least one of timestamp data indicative of a time the transaction occurred, purchase data indicative of a product, i.e., a good or service, that has been purchased and/or leased by the customer, purchase amount data indicative of an amount of funds transferred from the cardholder to the merchant, cardholder data indicative of the identity of the cardholder, and/or merchant data indicative of the identity of the merchant. In at least one implementation, merchant data also includes data associated with the merchant's current operations, such as current employee schedules and current payroll data.

A transaction monitoring module described herein determines the number of transactions performed with the merchant, referred to as a transaction count or transaction volume, for a plurality of time periods of interest based on the transaction data. The transaction monitoring module may receive time periods of interest from the merchant, or the time periods may be predefined and stored in a memory device. In one implementation, the transaction monitoring module determines a final transaction count for each time period by incrementing a current transaction count for each time period associated with the timestamp data of the payment transaction. For example, the transaction monitoring module determines a transaction count for each hour of each day in a week. The transaction monitoring module may also calculate other values associated with the time period of interest, such as a total transaction amount, average transaction amount, etc.

The transaction monitoring module also generates a transaction matrix, e.g., a matrix, a table, a graph, and/or any other data structure having one, two, three, or more dimensions. The transaction matrix has a plurality of cells, e.g., data elements, bins, etc. associated with a respective time period of interest. In the example embodiment, each cell of the transaction matrix is populated with the transaction count, total transaction amount, and/or other data relating to transactions performed with the merchant. At least a portion of the transaction matrix is transmitted to the merchant for use in facilitating merchant operations. For example, the merchant may assign employee schedules, set hours-of-operation, and/or set special events based on the transaction matrix in order to reduce operating costs or generate additional transactions. In one implementation, periods of high-transaction-volume and low-transaction-volume are determined by the transaction monitoring module, and the transaction monitoring module recommends merchant operations closely matched to the transaction volume. For example, the transaction monitoring module recommends an employee work schedule such that more employees are scheduled during time periods with high transaction volume and fewer employees are scheduled during time periods with low transaction volume. Alternatively, or additionally, the system may recommend merchant hours-of-operation that decrease operation during hours with low transaction volume.

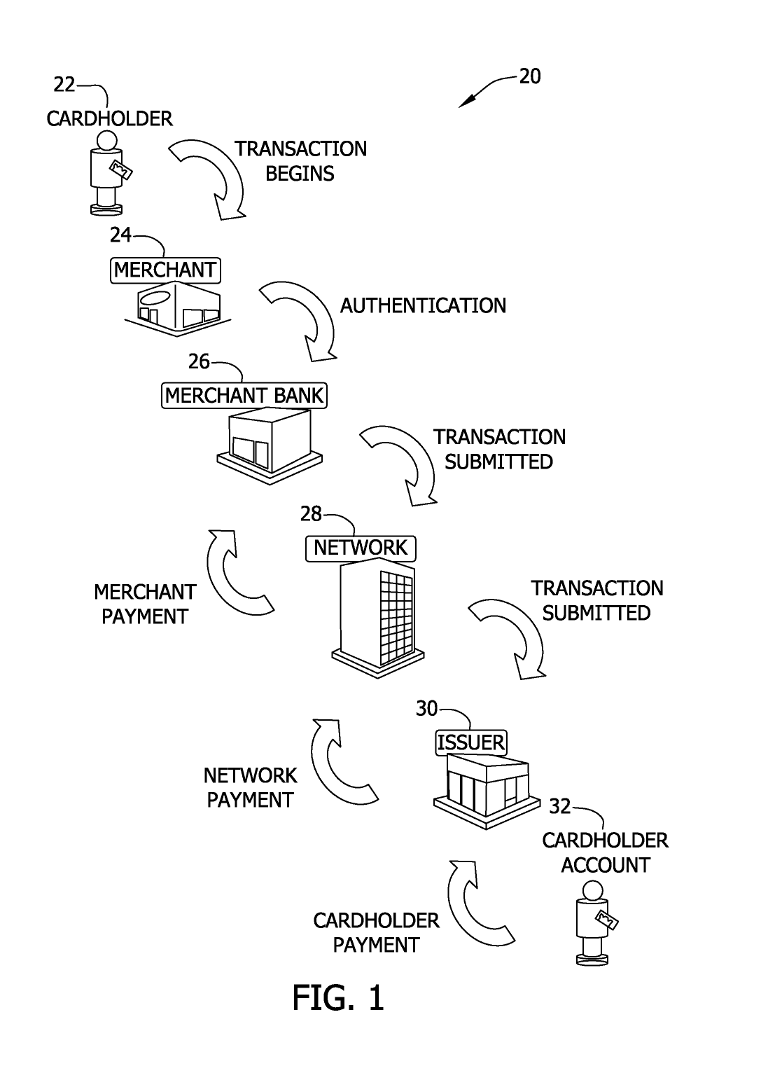

FIG. 1 is a schematic diagram illustrating an example multi-party transaction system 20 for enabling ordinary payment transactions in which merchants 24 and card issuers 30 do not need to have a one-to-one special relationship. Embodiments described herein may relate to a transaction system, such as the payment network operated by MasterCard International Incorporated, the assignee of the present disclosure. Such a network is comprised, in part, of a set of proprietary communications standards and protocols for the exchange of financial transaction data and the settlement of funds between financial institutions that are members of the payment network.

In a typical payment system, a financial institution called the “issuer” 30 issues a payment card, such as a credit card, debit card, electronic check, paper check or any other form of payment, to a cardholder 22, who uses the payment card to tender payment for a purchase from a merchant 24. Although referred to as a cardholder, cardholder 22 may use any type of payment method, including, but not limited to, a credit card, a debit card, a check, a mobile phone with access to a bank account, etc. to tender payment to merchant 24. To accept payment with the payment card, merchant 24 must normally establish an account with a financial institution that is part of the financial payment system. This financial institution is usually called the “merchant bank,” the “acquiring bank,” or the “acquirer.” When cardholder 22 tenders payment for a purchase with a payment card, merchant 24 requests authorization from a merchant bank 26 for the amount of the purchase. The request may be performed over the telephone, but is usually performed through the use of a point-of-sale (POS) terminal, which reads cardholder's 22 account information from a magnetic stripe, a chip, or embossed characters on the payment card that may be manually inputted into the POS terminal, and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using a payment network 28, computers of merchant bank 26 or merchant processor will communicate with computers of an issuer bank 30 to determine whether the payment transaction should be authorized. This may include a number of factors such as, whether cardholder's 22 account 32 is in good standing, and whether the purchase is covered by cardholder's 22 available credit line. If the request is accepted, an authorization code is issued to merchant 24.

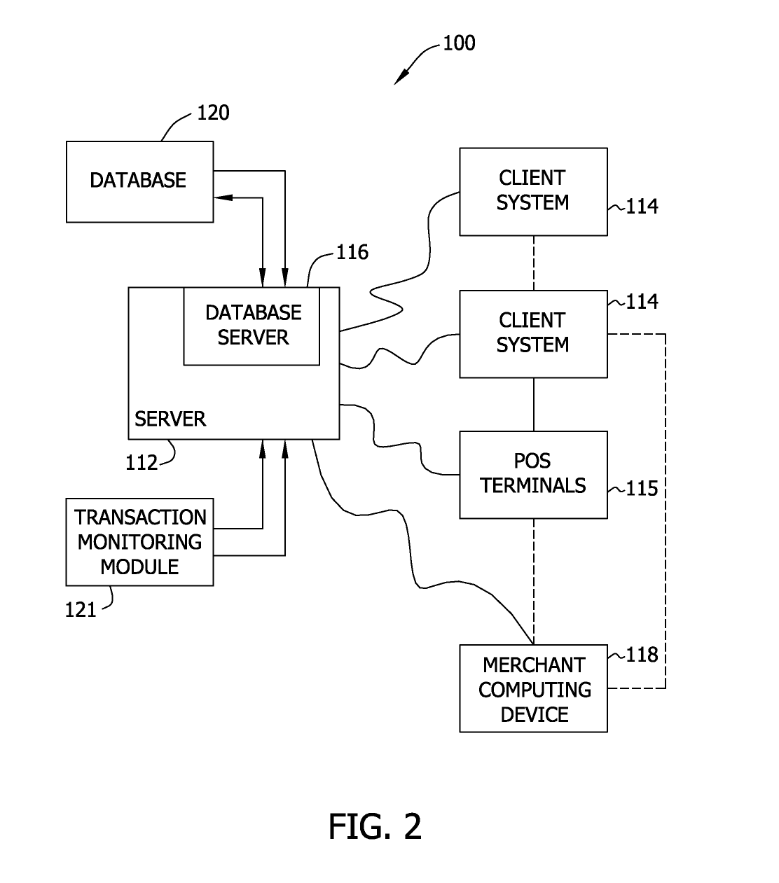

When a request for authorization is accepted, the available credit line of cardholder's 22 account 32 is decreased. In some cases, a charge for a payment transaction may not be posted, i.e., “captured” immediately to cardholder's 22 account 32, whereas in other cases, especially with respect to at least some debit card transactions, a charge may be posted or captured at the time of the transaction. In some cases, when merchant 24 ships or delivers the goods or services, merchant 24 captures the transaction by, for example, appropriate data entry procedures on the POS terminal. This may include bundling of approved transactions daily for standard retail purchases. If cardholder 22 cancels a transaction before it is captured, a “void” is generated. If cardholder 22 returns goods after the transaction has been captured, a “credit” is generated. Payment network 28 and/or issuer bank 30 stores the payment card information, such as a type of merchant, amount of purchase, date of purchase, in a database 120 (shown in FIG. 2).

For debit card transactions, when a request for a PIN authorization is approved by the issuer, the consumer's account is decreased. Normally, a charge is posted immediately to a consumer's account. The issuer 30 then transmits the approval to the merchant bank 26 via the payment network 28, with ultimately the merchant 24 being notified for distribution of goods/services, or information or cash in the case of an ATM. Although described with respect to debit and credit cards, the payment card may be an electronic check, mobile device with access to a cardholder's account, or any other form of payment.

After a purchase has been made, a clearing process occurs to transfer additional transaction data related to the purchase among the parties to the transaction, such as merchant bank 26, payment network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction. In the example embodiment, when cardholder 22 purchases travel, such as airfare, a hotel stay, and/or a rental car, at least partial itinerary information is transmitted during the clearance process as transaction data. When payment network 28 receives the itinerary information, payment network 28 routes the itinerary information to database 120 (shown in FIG. 2).

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and payment network 28, and then between payment network 28 and merchant bank 26, and then between merchant bank 26 and merchant 24.

FIG. 2 is a simplified block diagram of an example payment network 100 including a plurality of computer devices, such as server system 112, client systems 114, merchant computing device 118, and transaction monitoring module 121. In one embodiment, payment network 100 offers merchant services in accordance with one embodiment of the present invention. Specifically, payment network 100 implements a process that leverages transaction data to determine a transaction count for merchant 24 (shown in FIG. 1) at particular periods of time. In the example embodiment, a transaction matrix including the transaction count is transmitted to merchant 24 for use in facilitating merchant operations, such as employee scheduling as described below.

More specifically, in the example embodiment, network 100 includes a server system 112, and a plurality of client sub-systems, also referred to as client systems 114, connected to server system 112. In one embodiment, client systems 114 are computers including a web browser, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed Integrated Services Digital Network (ISDN) lines. Client systems 114 could be any device capable of interconnecting to the Internet including a web-based phone, PDA, or other web-based connectable equipment.

Network 100 also includes point-of-sale (POS) terminals 115, which may be connected to client systems 114, may be connected to server system 112, and may be connected to merchant computing device 118. POS terminals 115 are interconnected to the Internet through many interfaces including a network, such as a local area network (LAN) or a wide area network (WAN), dial-in-connections, cable modems, wireless modems, and special high-speed ISDN lines. POS terminals 115 could be any device capable of interconnecting to the Internet and including an input device capable of reading information from a consumer's payment card.

A database server 116 is connected to database 120, which contains information on a variety of matters, as described below in greater detail. In one embodiment, centralized database 120 is stored on server system 112 and can be accessed by potential users at one of client systems 114 by logging onto server system 112 through one of client systems 114. In an alternative embodiment, database 120 is stored remotely from server system 112 and may be non-centralized.

Database 120 may include a single database having separated sections or partitions or may include multiple databases, each being separate from each other. Database 120 may store transaction data generated as part of sales activities conducted over the processing network, including data relating to merchants, account holders or customers, issuers, acquirers, and/or purchases made. In one implementation, database 120 stores transaction data including at least one of timestamp data indicative of a time the transaction occurred, purchase data indicative of a product, i.e., a good or service, that has been purchased and/or leased, fund data indicative of an amount of funds associated with the transaction, merchant data including a merchant identifier that identifies the merchant associated with the payment transaction, and/or cardholder data including at least one of a cardholder name, a cardholder address, an account number, and other account identifier. Database 120 may store the merchant identifier in a list that identifies each merchant registered to use the network, and instructions for settling transactions including merchant bank account information.

In one embodiment, transaction monitoring module 121 is in communication with server system 112. Transaction monitoring module 121 provides services that enable merchant 24 to monitor payment transactions performed by cardholders 22 (shown in FIG. 2) with merchant 24. Specifically, in the example embodiment, cardholder 22 initiates a payment transaction with merchant 24 who communicates an authorization request and transaction data to merchant bank 26. Merchant bank 26 uploads the authorization request and transaction data to payment network 100, which communicates with issuer 30 (shown in FIG. 2) to determine if the payment transaction should be authorized.

In the example embodiment, transaction monitoring module 121 communicates with payment network 100 to receive the transaction data. In one implementation, all of the transaction data is associated with merchant 24. Alternatively, the transaction data is for any number of merchants. Transaction monitoring module 121 processes the transaction data associated with the payment transaction to determine at least merchant data and timestamp data. The merchant data identifies merchant 24, and the timestamp data indicates the time of the payment transaction, for example, the time-of-day and the calendar date associated with the payment transaction. In some implementations, transaction monitoring module 121 further processes the transaction data to determine the purchase amount associated with the payment transaction.

Transaction monitoring module 121 also determines a transaction count associated with merchant 24 for a plurality of time periods of interest. More specifically, transaction monitoring module 121 increments a current transaction count associated with one of the plurality of time periods based on the timestamp data associated with the payment transaction. For example, if the timestamp data indicated the payment transaction was initiated at 5:30, the transaction counter associated with time period 5:00-6:00, for example, would be incremented. This process is repeated for each payment transaction associated with merchant 24 until all of the payment transactions are processed. Once each payment transaction is processed, transaction monitoring module 121 determines a final transaction count that represents a volume of transactions performed by cardholders 22 at merchant 24 during the time period. In at least one implementation, the transaction monitoring module 121 may calculate a total transaction amount associated with each period of time and/or an average transaction amount associated with each period of time.

Also, in the example embodiment, transaction monitoring module 121 generates a transaction matrix having a plurality of cells, each cell associated with a time period of interest. The final transaction count, the total transaction amount, the average transaction amount, and/or other data is stored in the cell associated with the same time period of interest as the data. For example, the cells of the transaction matrix include the transaction count for their respective time period of interest. The plurality of time periods are each defined by a respective start time and end time. For example, the start time and the end time may be temporally spaced apart by hours, days, weeks, months, years, or any other period of time. In the example embodiment, the time periods are continuous, such that the end time for a first time period is the start time for a second time period. Alternatively, the time periods may be non-continuous, for example, skipping time periods where merchant 24 is closed. The plurality of time periods typically have an equal time duration, such as one hour each. Alternatively, the plurality of time periods may have different durations with respect to each other. In one implementation, the time periods may be selectively controlled by merchant 24. In other implementations, the time periods may be predefined.

In the exemplary embodiment, the transaction matrix is provided to merchant 24 for use in facilitating merchant operations. Specifically, the transaction matrix may be utilized to improve employee scheduling, improve special event timing, and/or improve hours-of-operation for merchant 24. In at least one embodiment, transaction monitoring module 121 recommends a merchant operation schedule, such as a recommended employee work schedule and/or a recommended hours-of-operation schedule based on the transaction matrix.

Network 100 also includes at least one merchant computing device 118, which is configured to communicate with at least one of POS terminal 115, client systems 114 and server system 112. In the exemplary embodiment, merchant computing device 118 is associated with or controlled by a merchant for performing a payment transaction. Merchant computing device 118 is interconnected to the Internet through many interfaces including a network, such as a local area network (LAN) or a wide area network (WAN), dial-in-connections, cable modems, wireless modems, and special high-speed ISDN lines. Merchant computing device 118 could be any device capable of interconnecting to the Internet including a web-based phone, personal digital assistant (PDA), or other web-based connectable equipment. In one embodiment, merchant computing device 118 is configured to communicate with client system 114 using various outputs including, for example, Bluetooth communication, radio frequency communication, near field communication, network-based communication, and the like. More specifically, in one embodiment, merchant computing device 118 communicates with client system 114 through a website associated with client system 114.

In the example embodiment, one of client systems 114 may be associated with an acquirer bank; while another one of client systems 114 may be associated with an issuer; POS terminal 115 and merchant computing device 118 may be associated with merchant 24; and server system 112 may be associated with payment network 100.

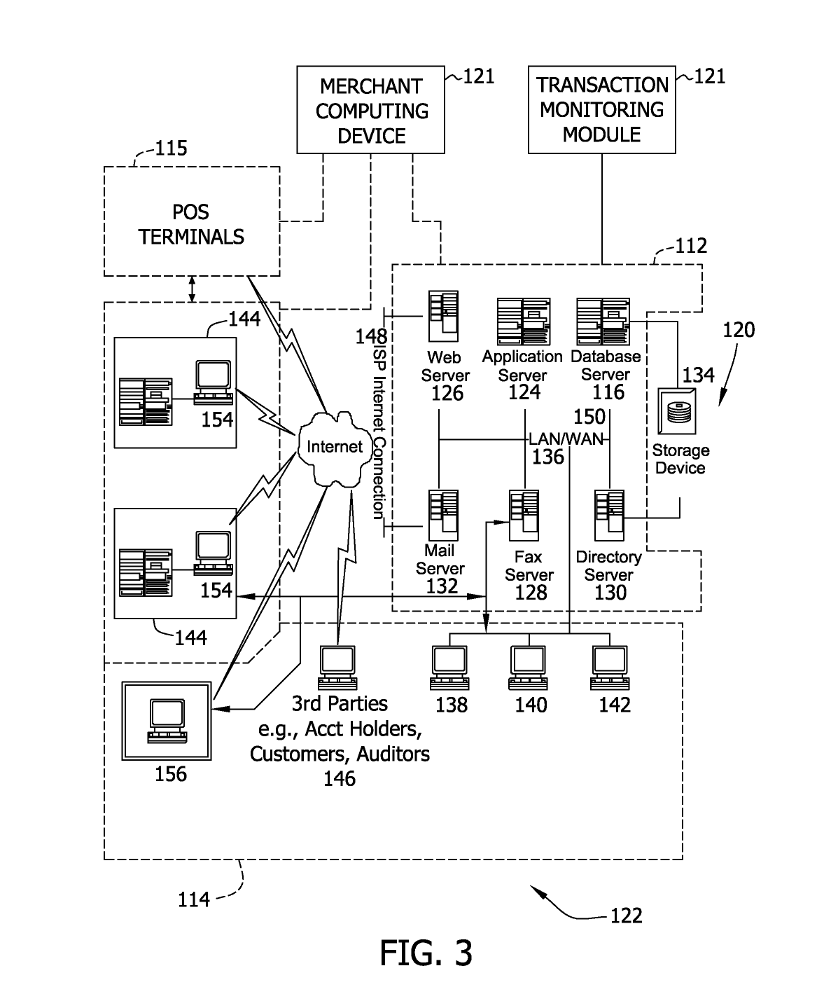

FIG. 3 is an expanded block diagram of an example server architecture of processing system 122 including other computer devices in accordance with one embodiment of the present invention. Processing system 122 comprises components identical to components of payment network 100 (shown in FIG. 2), those components are identified in FIG. 3 using the same reference numerals as used in FIG. 2. Processing system 122 includes server system 112, client systems 114, POS terminals 115, merchant computing device 118, and transaction monitoring module 121. Server system 112 further includes database server 116, an application server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a user workstation 140, and a supervisor's workstation 142 are coupled to LAN 136. Alternatively, workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet and a WAN type communication, however, any other type communication can be utilized in other embodiments, i.e., the systems and processes are not limited to being practiced using the Internet. In addition, rather than WAN 150, LAN 136 could be used.

In the example embodiment, any authorized individual having a workstation 154 can access processing system 122. At least one of the client systems 114 includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

Transaction monitoring module 121 may communicate with server system 112 through any suitable network communication method including, but not limited to, Wide Area Network (WAN) 150 type communications, LAN 136 type communications, 3G type communications, or Worldwide Interoperability for Microwave Access (WIMAX) type communications.

Merchant computing device 118 may communicate with server system 112, POS terminal 115, and client systems 114 through any suitable network communication method including, but not limited to, WAN 150 type communications, LAN 136 type communications, 3G type communications, or WIMAX type communications.

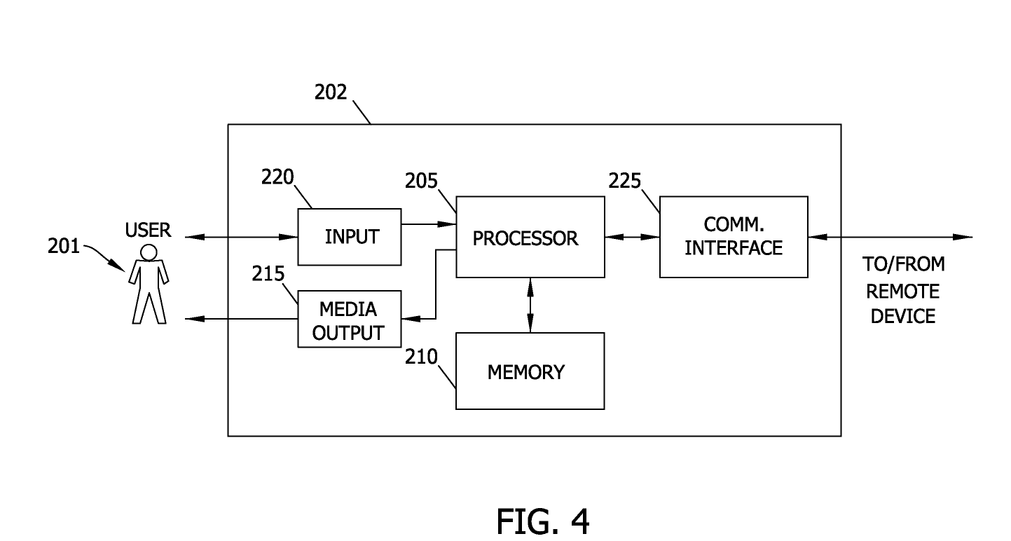

FIG. 4 illustrates an example configuration of a user system 202 operated by a user 201, such as an individual associated with merchant 24 (shown in FIG. 1). User system 202 may include, but is not limited to, client systems 114, 138, 140, and 142, POS terminal 115, merchant computing device 118, workstation 154, and manager workstation 156. In the example embodiment, user system 202 includes a processor 205 for executing instructions. In some embodiments, executable instructions are stored in a memory area 210. Processor 205 may include one or more processing units, for example, a multi-core configuration. Memory area 210 is any device allowing information, such as executable instructions and/or written works, to be stored and retrieved. Memory area 210 may include one or more computer readable media.

User system 202 also includes at least one media output component 215 for presenting information to user 201. Media output component 215 is any component capable of conveying information to user 201. In some embodiments, media output component 215 includes an output adapter such as a video adapter and/or an audio adapter. An output adapter is operatively coupled to processor 205 and operatively couplable to an output device such as a display device, a liquid crystal display (LCD), organic light emitting diode (OLED) display, or “electronic ink” display, or an audio output device, such as a speaker or headphones.

In some embodiments, user system 202 includes an input device 220 for receiving input from user 201. Input device 220 may include, for example, a keyboard, a pointing device, a mouse, a stylus, a touch sensitive panel, a touch pad, a touch screen, a gyroscope, an accelerometer, a position detector, and/or an audio input device. A single component such as a touch screen may function as both an output device of media output component 215 and input device 220. User system 202 may also include a communication interface 225, which is communicatively couplable to a remote device such as server system 112. Communication interface 225 may include, for example, a wired or wireless network adapter or a wireless data transceiver for use with a mobile phone network, Global System for Mobile communications (GSM), 3G, or other mobile data network such as WIMAX.

Stored in memory area 210 are, for example, computer readable instructions for providing a user interface to user 201 via media output component 215 and, optionally, receiving and processing input from input device 220. A user interface may include, among other possibilities, a web browser and client application. Web browsers enable users, such as user 201, to display and interact with media and other information typically embedded on a web page or a website from server system 112. A client application allows user 201 to interact with a server application from server system 112.

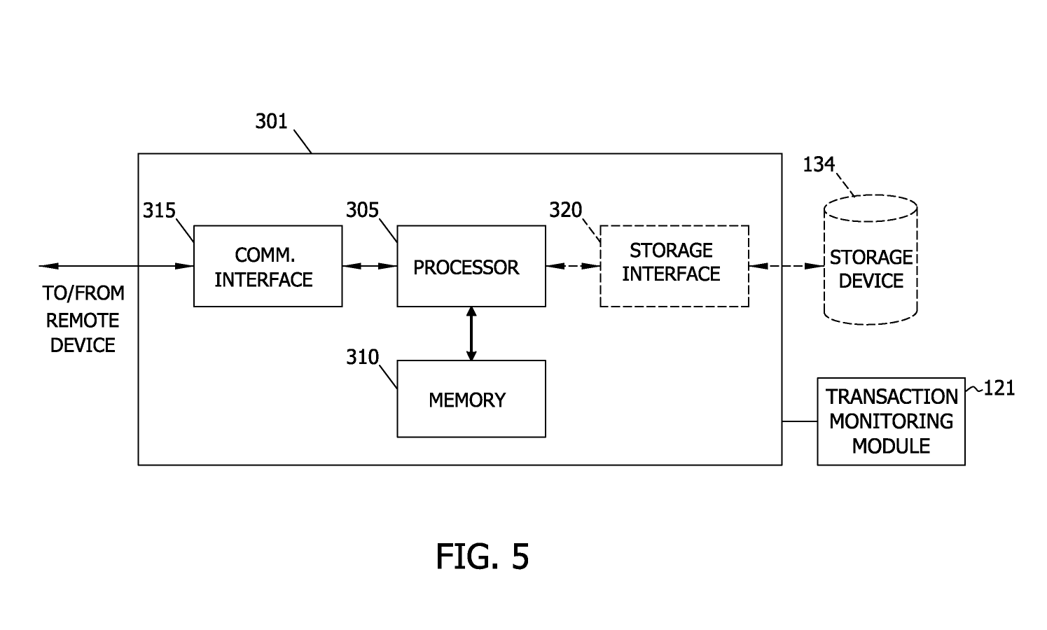

FIG. 5 illustrates an example configuration of a server system 301 such as server system 112 (shown in FIGS. 2 and 3). Server system 301 may include, but is not limited to, database server 116, application server 124, web server 126, fax server 128, directory server 130, and mail server 132.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Server system 301 may be communicatively coupled to transaction monitoring module 121. Transaction monitoring module 121 enables server system 301 to offer merchant services, including services to improve employee scheduling and/or improve hours-of-operation selection. In the example embodiment, transaction monitoring module 121 may be external to server system 301 and may be accessed by multiple server systems 301. For example, transaction monitoring module 121 may be a stand-alone computing device coupled to a memory unit. In some embodiments, transaction monitoring module 121 may be integrated with server system 301. For example, transaction monitoring module 121 may be a specifically programmed section of server system 301 configured to perform the functions described herein when executed by processor 305.

Processor 305 is operatively coupled to a communication interface 315 such that server system 301 is capable of communicating with a remote device such as a user system or another server system 301. For example, communication interface 315 may receive requests from client system 114 and merchant computing device 118 via the Internet, as illustrated in FIGS. 2 and 3.

Processor 305 may be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

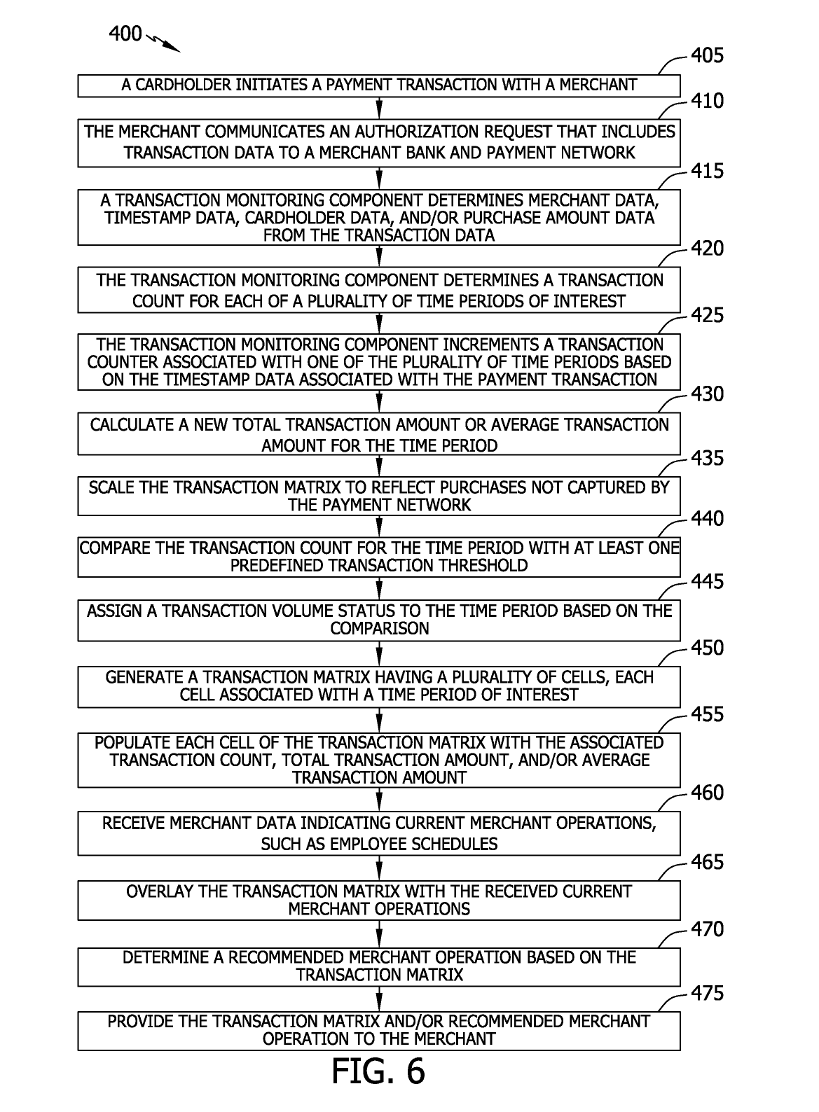

FIG. 6 is a simplified flowchart illustrating an example process 400 implemented by payment network 100 (shown in FIG. 2) having a transaction monitoring module 121 to leverage transaction data. In the example embodiment, cardholder 22 (shown in FIG. 1) initiates 405 a payment transaction with merchant 24. In response, merchant 24 communicates 410 an authorization request that includes transaction data associated with the payment transaction to merchant bank 26. Merchant bank 26 uploads the transaction data to payment network 100, which communicates with issuer 30 (shown in FIG. 2) to determine if the payment transaction should be authorized.

Transaction monitoring module 121 (shown in FIG. 2) processes the transaction data to determine 415 at least one of merchant data, timestamp data, cardholder data, and purchase amount data. Transaction monitoring module 121 utilizes merchant data to identify merchant 24 associated with the payment transaction, and timestamp data to determine the time associated with the payment transaction.

Transaction monitoring module 121 also determines 420 a transaction count for a plurality of time periods based on transaction data for a plurality of payment transactions. More specifically, transaction monitoring module 121 increments 425 a transaction counter associated with one of the plurality of time periods based on the timestamp data associated with each payment transaction. For example, if the timestamp data indicated a payment transaction was initiated at 5:30, the transaction counter associated with time period 5:00-6:00, for example, would be incremented.

In at least one implementation, the transaction monitoring module 121 may also calculate 430 a new total transaction amount and/or average transaction amount associated with the period of time. The total transaction amount is calculated 430 by summing the purchase amount of each payment transaction associated with each time period. The average transaction amount is calculated 430 by dividing the total transaction amount by the transaction counter.

This process is repeated for each of the plurality of payment transactions associated with merchant 24 to determine a final transaction count that represents the volume of transactions performed by cardholders 22 at merchant 24 during a particular time period. In at least one embodiment, transaction monitoring module 121 scales 435 the transaction matrix to reflect purchases not captured by payment network 100, e.g., cash purchases. For example, the transaction counter and/or total transaction amount may be multiplied by a factor to estimate total transactions performed with merchant 24.

Further, transaction monitoring module 121 compares 440 the transaction counter for each time period with at least one predefined threshold to determine a transaction volume status associated with the time period. For example, if the predefined threshold is ten transactions and the transaction counter for a time period is above ten, transaction monitoring module 121 assigns 445 a high transaction volume status to the time period. Alternatively, if the predefined threshold is ten transactions and the transaction counter for a time period is less than ten, transaction monitoring module 121 assigns 445 a low transaction volume status to the time period. In at least one embodiment, the transaction counter is compared 440 with a plurality of predefined thresholds such that three or more transaction volume statuses are defined.

Moreover, transaction monitoring module 121 generates 450 a transaction matrix having a plurality of cells, each cell associated with a time period of interest. The final transaction count, the total transaction amount, the average transaction amount, and/or other data is populated 455 in the cell associated with the same time period of interest as the data. For example, the cells of the transaction matrix include the transaction count for their respective time period of interest.

Also, in the example embodiment, transaction monitoring module 121 receives 460 merchant data indicating current merchant operations, such as a current employee schedule. Transaction monitoring module 121 overlays 465 the transaction matrix with the current merchant operations such that time periods of interest overlap.

In addition, the transaction monitoring module 121 determines 470 a recommended merchant operation, such as a recommended employee work schedule, a recommended special event time, and/or a recommended hours-of-operation schedule based on the transaction matrix. In one implementation, transaction monitoring module 121 may recommend a schedule with more employees scheduled to work during time periods with higher transaction counts, and schedule fewer employees to work during time periods with lower transaction counts. In another implementation, transaction monitoring module 121 may recommend a schedule with more employees scheduled to work during time periods with higher total transaction amounts or higher average transaction amounts relative to other time periods. For example, a restaurant may have time periods with similar transaction counts, but one time period may have had large groups of customers associated with a higher total transaction amount than the other time period, requiring additional employees. Specifically, transaction monitoring module 121 correlates at least one of the total transaction amount and average transaction amount with the need for goods and/or services from merchant 24, and recommends merchant operations based on the correlation.

In the example embodiment, the transaction monitoring module 121 transmits 475 at least a portion of the transaction matrix to merchant 24 to facilitate merchant operations. Specifically, the transaction matrix may be utilized to improve employee scheduling and/or improve hours-of-operation selection by merchant 24.

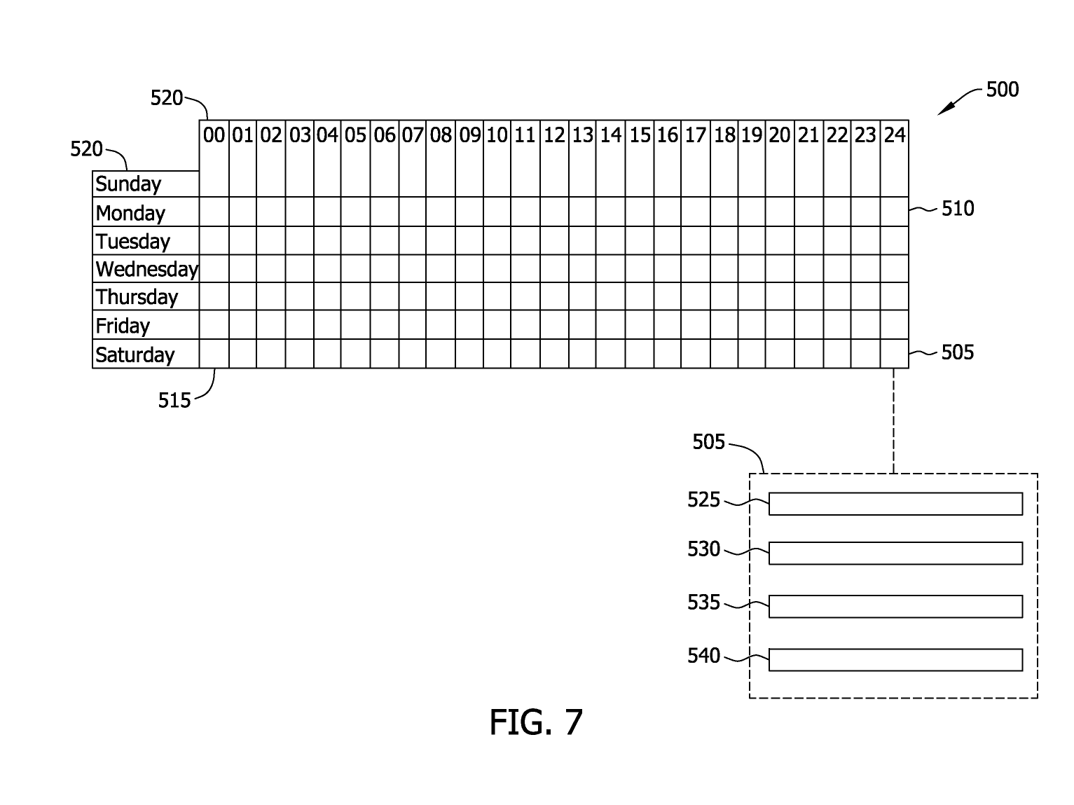

FIG. 7 is an example transaction matrix 500 generated by transaction matrix module 121 (shown in FIG. 1) for use in improving merchant operations. Transaction matrix 500 includes a plurality of cells 505. In the example embodiment, cells 505 are arranged in a plurality of rows 510 and columns 515. Alternatively, time periods 505 may be arranged in any manner and in any number of dimensions that enables transaction matrix 500 to function as described herein. Also, in the example embodiment, transaction matrix 500 includes at least one identifier 520 that defines a time period associated with each cell 505. In the example embodiment, identifier 520 may describe a day-of-week and/or a time-of-day. Alternatively, identifier 520 may be any method of identifying a time period associated with each cell 505.

Each cell 505 includes a transaction count 525, a total transaction amount 530, an average transaction amount 535, a transaction volume status 540, or any combination thereof. As described above, transaction count 525 describes the number of transactions initiated by cardholders 22 with merchant 24 during a time period of interest. Total transaction amount 530 is the sum of the purchase amounts for all payment transactions in each time period. Average transaction amount 535 is the average purchase amount of the payment transactions in each time period. Transaction volume status 540 indicates a transaction volume range associated with the time period, for example, high-transaction-volume and low-transaction-volume. In at least one embodiment, transaction status 540 may be displayed as a color in the background of each cell 505. Alternatively, transaction volume status 540 may be displayed in any manner that enables transaction matrix 500 to function as described herein.

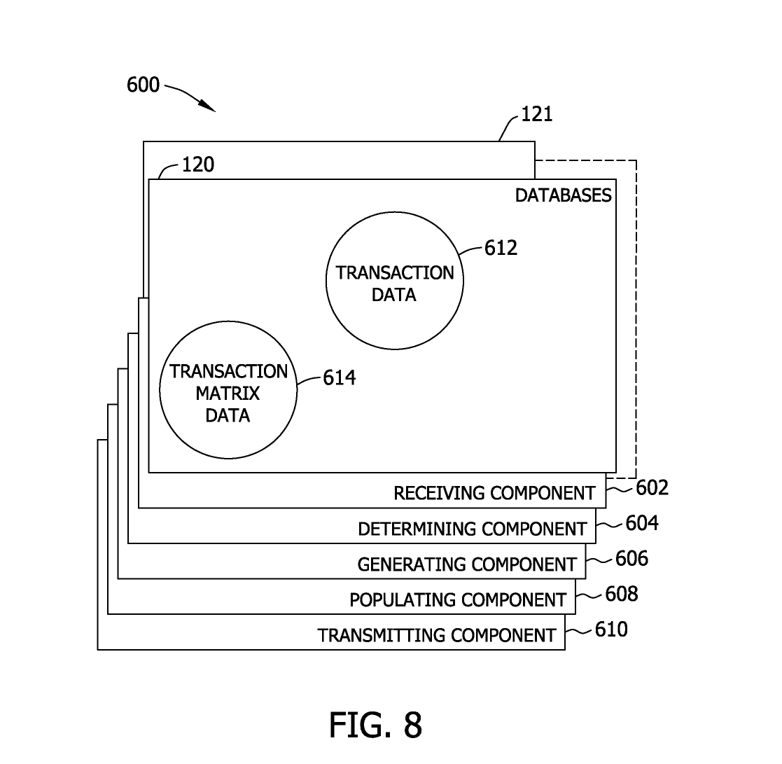

FIG. 8 is a diagram of a component layout of a computing device as shown in FIGS. 2-3. For example, one or more of computing devices may form transaction monitoring module 121.

Transaction monitoring module 121 includes a receiving component 602 for receiving transaction data that includes merchant data and timestamp data. Transaction monitoring module 121 also includes a determining component 604 that determines transaction count 525 (shown in FIG. 7), total transaction amount 530 (shown in FIG. 7), average transaction amount 535 (shown in FIG. 7), and transaction volume status 540 (shown in FIG. 7). Transaction monitoring module 121 also includes a generating component 606 for generating a transaction matrix including a plurality of cells associated that are each associated with a time period of interest. Transaction monitoring module 121 also includes a populating component 608 for populating cells 505 of transaction matrix 500. Specifically, populating component 608 populates cells 505 with transaction counts 525, total transaction amounts 530, average transaction amounts 535, and/or transaction volume statuses 540. Transaction monitoring module 121 also includes a transmitting component 610 for transmitting at least a portion of transaction matrix 500 to a merchant. Transmitting component 610 may also transmit a recommended merchant operation to the merchant.

Further in the example embodiment, transaction monitoring module 121 is in communication with database 120. Database 120 may store transaction data 612 for each of the payment transactions performed over payment network 100. Database 120 may also store the transaction matrix data 614. The transaction matrix data including the transaction counts 525, total transaction amounts 530, average transaction amounts 535, and/or transaction volume statuses 540.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processor 212, including RAM memory, ROM memory, EPROM memory, EEPROM memory, and non-volatile RAM (NVRAM) memory. The above memory types are examples only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is for (a) receiving, by the transaction monitoring module, payment transaction data associated with a plurality of payment transactions, wherein the payment transaction data includes timestamp data indicative of a time of each payment transaction; (b) determining a transaction count for each of a plurality of time periods of interest based on the timestamp data, wherein each transaction count indicates the number of transactions performed with a merchant during the respective time period of interest; (c) generating, using the transaction monitoring module, a transaction matrix for the merchant, wherein the transaction matrix includes a plurality of cells, and each cell is associated with a respective time period of interest; (d) populating each cell of the transaction matrix with the transaction count associated with the time period of interest of the cell; and (e) transmitting at least a portion of the transaction matrix to the merchant.

Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

The above-described embodiments of a method and system of leveraging transaction data to facilitate merchant operations provide a cost-effective and reliable means for improving scheduling of employees. Specifically, the transaction data facilitates a merchant understanding periods of high transaction volume where a relatively high number of employees are required, and a period of low transaction volume where a relatively low number of employees are required.

In addition, the above-described methods and systems facilitate improving the hours-of-operation for the merchant. More specifically, the transaction data facilitates a merchant understanding periods of high transaction volume where the merchant should remain open, and periods of low transaction volume, where reduced hours of operation may be more profitable. As a result, the methods and systems described herein facilitate providing improved hours of operation to a merchant in a cost-effective and reliable manner.

The operations described herein may be performed by a computer or computing device. A computer or computing device may include one or more processors or processing units, system memory, and some form of computer readable media. Exemplary computer readable media include flash memory drives, digital versatile discs (DVDs), compact discs (CDs), floppy disks, and tape cassettes. By way of example and not limitation, computer readable media comprise computer-readable storage media and communication media. Computer-readable storage media are tangible and non-transitory and store information such as computer readable instructions, data structures, program modules, or other data. Communication media, in contrast, typically embody computer readable instructions, data structures, program modules, or other data in a transitory modulated data signal such as a carrier wave or other transport mechanism and include any information delivery media. Combinations of any of the above are also included within the scope of computer readable media.

This written description uses examples to describe the disclosure, including the best mode, and also to enable any person skilled in the art to practice the disclosure, including making and using any devices or systems and performing any incorporated methods. The patentable scope of the application is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for facilitating merchant operations, said method implemented using a server system communicatively coupled to a transaction monitoring module and a memory device, said method comprising:
receiving, by the transaction monitoring module, payment transaction data associated with a plurality of payment transactions, wherein the payment transaction data includes timestamp data indicative of a time of each payment transaction;
determining a transaction count for each of a plurality of time periods of interest based on the timestamp data, wherein each transaction count indicates the number of transactions performed with a merchant during the respective time period of interest;
generating, using the transaction monitoring module, a transaction matrix for the merchant, wherein the transaction matrix includes a plurality of cells, and each cell is associated with a respective time period of interest;
populating each cell of the transaction matrix with the transaction count associated with the time period of interest of the cell; and
transmitting at least a portion of the transaction matrix to the merchant.

2. A method in accordance with claim 1 further comprising:
determining a recommended merchant operation based on the transaction matrix; and
transmitting the recommended merchant operation to the merchant.

3. A method in accordance with claim 2, wherein determining a recommended merchant operation includes at least one of:
determining a recommended hours-of-operation for the merchant; and
determining a recommended employee work schedule for the merchant.

4. A method in accordance with claim 1 further comprising:
receiving a purchase amount for each payment transaction; and
calculating at least one of an average transaction amount and a total transaction amount for each cell of the transaction matrix based on the received purchase amounts.

5. A method in accordance with claim 4 further comprising providing a recommended merchant operation based on at least one of the total transaction amount and the average transaction amount.

6. A method in accordance with claim 5 further comprising correlating at least one of the total transaction amount and the average transaction amount with an increased demand for particular services.

7. A method in accordance with claim 1 further comprising:
defining at least a high-transaction volume range and a low-transaction volume range;
comparing the transaction count for at least one cell with the high-transaction-volume range and the low-transaction-volume range; and
assigning at least one of a high-transaction volume status and a low transaction volume status to the at least one cell based on the comparison.

8. A method in accordance with claim 1 further comprising multiplying the plurality of transaction counts by a scaling factor to approximate payment transactions initiated with the merchant and not received by the transaction monitoring module.

9. A method in accordance with claim 1, wherein each of the plurality of cells defines a distinct time-of-day and day-of-week in the transaction matrix.

10. A method in accordance with claim 1 further comprising:
receiving, by the transaction monitoring module, merchant overlay data, wherein the merchant overlay data includes data associated with at least one of a merchant employee work schedule and a merchant payroll; and
overlaying the received merchant overlay data on the transaction matrix.

11. A method in accordance with claim 1, wherein each time period of interest includes a start time and an end time, and the start time and the end time are separated by at least one of an hour, a day, a week, a month, and a year.

12. A server system for facilitating merchant operations, said server system comprising:
a computing device including a memory and a processor coupled to the memory; and
a transaction monitoring module coupled to the computing device, the transaction monitoring module configured to:
receive payment transaction data associated with a plurality of payment transactions, wherein the payment transaction data includes timestamp data indicative of a time of each payment transaction;
determine a transaction count for each of a plurality of time periods of interest based on the timestamp data, wherein each transaction count indicates the number of transactions performed with a merchant during the respective time period of interest;
generate a transaction matrix for the merchant, wherein the transaction matrix includes a plurality of cells, and each cell is associated with a respective time period of interest;
populate each cell of the transaction matrix with the transaction count associated with the time period of interest of the cell; and
transmit at least a portion of the transaction matrix to the merchant.

13. A system in accordance with claim 12, wherein the transaction monitoring module is further configured to:
determine a recommended merchant operation based on the transaction matrix; and
transmit the recommended merchant operation to the merchant.

14. A system in accordance with claim 13, wherein the recommended merchant operation is at least one of a recommended hours-of-operation for the merchant and a recommended employee work schedule for the merchant.

15. A system in accordance with claim 12, wherein the transaction monitoring module is further configured to:
receive a purchase amount for each payment transaction; and
calculate at least one of an average transaction amount and a total transaction amount for each cell of the transaction matrix based on the received purchase amounts.

16. A system in accordance with claim 12, wherein the transaction monitoring module is further configured to:
define at least a high-transaction volume range and a low-transaction volume range;
compare the transaction count for at least one cell with the high-transaction-volume range and the low-transaction-volume range; and
assign at least one of a high-transaction volume status and a low transaction volume status to the at least one cell based on the comparison.

17. A system in accordance with claim 12, wherein the transaction monitoring module is further configured to multiply the plurality of transaction counts by a scaling factor to approximate payment transactions initiated with the merchant and not received by the transaction monitoring module.

18. A system in accordance with claim 12, wherein the transaction monitoring module is further configured to:
receive merchant overlay data, wherein the merchant overlay data includes data associated with at least one of a merchant employee work schedule and a merchant payroll; and
overlay the received merchant overlay data on the transaction matrix.

19. A computer readable medium having computer-executable instructions for facilitating merchant operations embodied thereon, wherein, when executed by at least one processor, cause the at least one processor to:
receive payment transaction data associated with a plurality of payment transactions, wherein the payment transaction data includes timestamp data indicative of a time of each payment transaction;
determine a transaction count for each of a plurality of time periods of interest based on the timestamp data, wherein each transaction count indicates the number of transactions performed with a merchant during the respective time period of interest;
generate a transaction matrix for the merchant, wherein the transaction matrix includes a plurality of cells, and each cell is associated with a respective time period of interest;
populate each cell of the transaction matrix with the transaction count associated with the time period of interest of the cell; and
transmit at least a portion of the transaction matrix to the merchant.

20. A computer-readable medium in accordance with claim 19, wherein the computer-executable instructions further cause the at least one processor to:
determine a recommended merchant operation based on the transaction matrix; and
transmit the recommended merchant operation to the merchant.

21. A computer-readable medium in accordance with claim 20, wherein the recommended merchant operation is one of a recommended hours-of-operation for the merchant and a recommended employee work schedule for the merchant.

22. A computer-readable medium in accordance with claim 19, wherein the computer-executable instructions further cause the at least one processor to:
receive a purchase amount for each payment transaction; and
calculate at least one of an average transaction amount and a total transaction amount for each cell of the transaction matrix based on the received purchase amounts.

23. A computer-readable medium in accordance with claim 19, wherein the computer-executable instructions further cause the at least one processor to:
define at least a high-transaction volume range and a low-transaction volume range;
compare the transaction count for at least one cell with the high-transaction-volume range and the low-transaction-volume range; and
assign at least one of a high-transaction volume status and a low transaction volume status to the at least one cell based on the comparison.

24. A computer-readable medium in accordance with claim 19, wherein the computer-executable instructions further cause the at least one processor to multiply the plurality of transaction counts by a scaling factor to approximate payment transactions initiated with the merchant and not received by the transaction monitoring module.

25. A computer-readable medium in accordance with claim 19, wherein the computer-executable instructions further cause the at least one processor to:
receive merchant overlay data, wherein the merchant overlay data includes data associated with at least one of a merchant employee work schedule and a merchant payroll; and
overlay the received merchant overlay data on the transaction matrix.
